(19) United States
(12) Patent Application Publication
(10) Pub. No.: US 2026/0267721 A1
(43) Pub. Date: Sep. 10, 2026

(54) Method for Determining at Least One Error Type of a Machine Learning Model

(71) Applicant: Robert Bosch GmbH, Stuttgart (DE)

(72) Inventors: Annika Hagemann, Hildesheim (DE); Jan Fabian Schmid, Hamburg (DE)

(21) Appl. No.: 19/559,568

(22) Filed: Mar. 6, 2026

(30) Foreign Application Priority Data
Mar. 10, 2025 (DE) 10 2025 108 854.3

(51) Int. Cl. G06F 11/07

(52) U.S. Cl. CPC G06F 11/0751; G06F 11/0715

(57) ABSTRACT

A method is disclosed for determining at least one error type of a machine learning model, in particular a computer vision model. The method includes (i) defining an assessment criterion for an output of a prediction of the machine learning model, (ii) performing the prediction based on at least one image using the machine learning model, wherein the prediction is performed for individual areas of the at least one image, (iii) analyzing the output of the performed prediction to identify at least one area in the at least one image, for which the output of the prediction satisfies the defined assessment criterion, (iv) generating local language embedding for the at least one identified area, and (v) determining the at least one error type based on an analysis of the generated local language embedding. A computer program, a device, and a storage medium for this purpose are also disclosed.

This application claims priority under 35 U.S.C. § 119 to patent application no. DE 10 2025 108 854.3, filed on Mar. 10, 2025 in Germany, the disclosure of which is incorporated herein by reference in its entirety.

The disclosure relates to a method for determining at least one error type of a machine learning model. The disclosure further relates to a computer program, a device, and a storage medium for this purpose.

### BACKGROUND

One of the main tasks in developing machine learning models for computer vision is to investigate possible error types of the developed model. For example, a machine learning model for object detection may fail when an object is partially obstructed, and a machine learning model for optical flow may fail for low-textured image areas. Recognizing and understanding such error types is essential to making sound statements about functionality of the machine learning model and determining what additional training data is needed. Understanding error types, however, is a time-consuming task according to the past procedure, which includes a lengthy visual inspection of images and model predictions by the developer. Especially with the advent of base models trained on ever increasing amounts of data, such a manual review becomes impossible.

A typical approach to detecting error types is visual inspection of images and model predictions by the developer. In addition, application-specific analyses may be performed, e.g., calculation of a precision of an object detection model separately for each object class.

For example, according to the prior art, CLIP may be employed to detect and understand the error types of a machine learning model. However, to date global language embeddings have been calculated for entire images, which is not very informative for local computer vision tasks such as object detection, optical flow, or object tracking.

### SUMMARY

The subject matter of the disclosure is a method, a computer program, an apparatus, and a computer-readable storage medium having the features set forth below. Further features and details of the disclosure result from the description and the drawings. Features and details which are described in connection with the method according to the disclosure naturally also apply in connection with the computer program according to the disclosure, the device according to the disclosure, and the computer-readable storage medium according to the disclosure, and vice versa in each case, so that a reciprocal reference is always possible with regard to the disclosure of the disclosure.

The subject matter of the disclosure is in particular a method for determining at least one error type of a machine learning model, in particular a computer vision model comprising:
defining an assessment criterion for an output of a prediction of the machine learning model, wherein the assessment criterion is particularly specific to a grade or precision of the output of the prediction,
performing the prediction based on at least one image, or for the at least one image, using the machine learning model, wherein the prediction for individual areas, e.g., individual pixels or pixel areas, of the at least one image is performed, wherein the prediction comprises, for example, a pixel-by-pixel prediction and/or object detection and/or a determination of an optical flow, wherein the at least one image may result from a detection of at least one sensor of a vehicle, for example,
analyzing the output of the performed prediction to identify at least one area, e.g., at least one single pixel or pixel area, in the at least one image, for which the output of the prediction satisfies the defined assessment criterion, wherein it may also be that no area in an image satisfies the defined assessment criterion, in which case the next steps are particularly not performed accordingly,
generating a local language embedding for the at least one identified area,
determining the at least one error type based on an analysis of the generated local language embedding.

The method may thus contribute to identifying specific error types in machine learning models, particularly computer vision models, by leveraging local information from the images and correlating it to the prediction outputs of the machine learning model. The analysis of the local language embeddings allows in particular a more detailed description of the error than conventional methods, which rely on global image information. This in particular allows for more targeted error tracing and can lead to an improvement in model performance through subsequent targeted training with relevant training data. The at least one error type may indicate what characteristic in the at least one image leads to satisfaction of the assessment criterion and may look like, for example, in the context of at least semi-automated driving: “a back side of a truck on a nighttime highway that is partially obscured by another truck.”

Furthermore, it is possible that, in the context of the disclosure, the assessment criterion is a threshold for precision of the prediction output and analyzing is based on a comparison of the prediction output with a ground truth, in particular at least one ground truth label, for the at least one image or ground truth label for the at least one identified area in the at least one image. This in particular allows precise identification of areas, in which the machine learning model does not satisfy the defined precision.

It may further be possible that, as part of performing the prediction, a respective confidence for predicting the individual areas of the image is further determined, wherein the assessment criterion is a threshold for the confidence, and the analysis is performed based on a comparison of the respective determined confidences with the threshold for the confidence. Put simply, with the confidence of the machine learning model, it can additionally be determined how confidently a particular prediction is estimated by the machine learning model for each individual area. Thus, particularly uncertain predictions can be identified and then further investigated based on the local language embeddings.

Furthermore, it is contemplated that the generation of local language embedding will be performed using a, particularly trained, vision language model, for example, PixelLLM (Xu et al. 2023). The local language embedding may comprise a feature vector representing the at least one identified area. This has the advantage that local language embedding can provide semantic information about the identified image area. As a result, the determination of the at least one error type can be more accurate and specific, since not only visual features but also the semantic information can be considered.

It may be further advantageous to provide that, as part of the analysis, a plurality of areas in the at least one image is identified, for which the output of the prediction satisfies the defined assessment criterion. The identified areas from a plurality of images, in particular from all images, can also be used here. The generating of the local language embedding is preferably performed for each of the identified areas. Preferably, the method further comprises:
clustering the generated local language embeddings, wherein similar error types are grouped into a respective cluster, wherein the clustering can be performed using a clustering algorithm, such as the k-means algorithm,
   wherein determining the at least one error type comprises:
analyzing the respective clusters to determine a specific error type for each cluster.

Specific categorization of error types may facilitate targeted identification of the various weaknesses of the machine learning model to subsequently adjust and improve the machine learning model.

It is noted here that in addition to local language embeddings of low precision areas, local language embeddings of high precision areas may also be produced. These high-precision local language embeddings can be used as a guide for clustering, as the error types should be particularly different from clusters with high precision.

Alternatively, rather than performing the clustering, the local language embeddings may also be further processed by a deep learning machine learning model to determine at least one error type.

It is also advantageous if determining at least one error type comprises:
converting the generated local language embedding into a natural language, particularly using a generative machine learning model.

This allows a user, like a developer, to better understand and purposefully fix at least one error type of the machine learning model.

Alternatively, instead of using the generative machine learning model, the conversion may be performed indirectly based on similarity assessments for language embeddings of predefined text excerpts. In particular, a set of relevant scenarios is defined, wherein each scenario is preferably described with natural language, i.e., in particular one text excerpt per scenario. By applying the machine learning model, particularly the vision language model, to the text excerpts, the associated language embedding can be generated for each scenario. The local language embeddings generated from the image can then be compared to the language embeddings of the scenarios and associated with the most similar scenario.

Furthermore, it is optionally possible within the scope of the disclosure for the method to also comprise:
initiating an output in accordance with an analysis of the at least one determined error type, wherein the output comprises an indication of a functionality of the machine learning model, and/or
wherein the output comprises an indication of further required training data for retraining the machine learning model, wherein the further required training data is specific to the at least one determined error type, and/or
wherein the output comprises the local language embedding converted to the natural language.

Thus, actions may be derived by a user, such as a developer, based on the output, for example, to provide further training data to specifically improve the machine learning model. The output may be a visual output by way of a display or an acoustic output by way of a speaker. Functionality may indicate whether the machine learning model is unsuitable for a specific use in a defined application, such as at least partially automated driving, due to the presence of at least one error type.

Preferably, the disclosure may provide that the method further comprises:
initiating a provision of further training data, in particular retrieving further training data from a data store or a database, based on an analysis of at least one determined error type, wherein the further training data is specific to the at least one determined error type, training or performing fine-tuning of the machine learning model using the retrieved further training data.

This has the advantage that the machine learning model can be improved by specifically providing additional training data specific to at least one error type. As a result, gaps in the machine learning model training may be closed and the precision of processing images with that particular error type may be increased.

It is possible for the method according to the disclosure to be used in a vehicle. The vehicle can be designed, for example, as a motor vehicle and/or passenger vehicle and/or at least partially automated/autonomous vehicle. The vehicle may have a vehicle device, for example, for providing an autonomous driving function and/or a driver assistance system. The vehicle device may be configured to control the vehicle at least partially automatically and/or to accelerate and/or brake and/or steer.

The machine learning model is in particular a trained machine learning model that has been trained to classify, determine an optical flow, or detect objects. The training may be provided to train the machine learning model using a training data set for classification, in particular for image classification, or for determining the optical flow of image data, such as digital images based on image points and/or pixels, particularly pixel values, preferably edges or pixel attributes (of the image data). The image data or digital images may result, for example, from a recording by at least one sensor, preferably at least one camera. The recording is possible by at least one camera of a vehicle, for example. The classification can be provided to detect or capture objects in an environment depicted by the image data or digital images.

The classification or determination of the optical flow may be provided for various technical applications. An example is in-vehicle application. Based on the classification, in particular at least one classification result, or the determined optical flow, at least one control action, preferably for a vehicle or for another technical system, can be initiated and/or performed.

The control action may include at least one of: braking, steering, accelerating, passing, emergency braking, an activation of an alarm system, an activation of a hazard warning light system, an activation of a turn signal, light control, or the like.

A classification result may comprise at least one of the following results and/or may be specific to at least one of the following results: a category of objects, an identification of objects, a location of objects and/or obstacles (e.g., in the direction of travel or adjacent to the direction of travel), a presence of obstacles, a description of a traffic scene, a hazard notification, a number of objects, a type and/or location of roadway markings and/or a roadway boundary, a location and/or a state of traffic signaling systems, a location of a roadway, or the like.

The “classification” and “image classification” may also include an “object detection” and/or “object detection in images”. This is particularly to be understood as a classification of whether or not objects are present in certain areas of the image. In addition, the terms “classification” and “image classification” may also refer to “semantic segmentation”, particularly in the form of a pixel-by-pixel classification.

Accordingly, at least one trained machine learning model may result from the training, which may be used for the classification and/or object detection and/or determination of the optical flow. The use, and thus the inference, may be provided, for example, in a vehicle. The data points of the input data can be pixels of image data or be based on these in order to carry out the classification and/or object detection and/or determination of the optical flow of the data points on the basis of the pixels. The input information can include sensor and/or image data that results at least in part from acquisition by way of a sensor, preferably a camera sensor, and/or which have been at least partially synthesized, i.e. in particular mimic the real data of a sensor. Specifically, it may be provided that an environment of a sensor and/or of a vehicle and/or a traffic scene is represented by the values of image points, preferably pixels, of the image data. A classification, preferably image classification and/or object detection and/or determination of the optical flow, on the basis of these values may be provided. This makes it possible to detect objects of the traffic scene, for example. The image data can be images of a radar sensor and/or of an ultrasound sensor and/or of a lidar sensor and/or of a thermal imaging camera. Accordingly, the images may also be configured as radar images and/or ultrasound images and/or thermal images and/or lidar images.

Another object of the disclosure is a computer program, in particular a computer program product, comprising instructions which, when the computer program is executed by at least one computer, cause the computer to carry out the method according to the disclosure. The computer program according to the disclosure thus brings about the same advantages as have been described in detail with reference to the method according to the disclosure.

The subject matter of the disclosure is also a device for data processing that is configured to execute the method according to the disclosure. The device can be at least one computer, for example, that executes the computer program according to the disclosure. The computer may have at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or commands that, when executed by at least one computer, prompt said computer program to carry out the method according to the disclosure. The storage medium is configured, for example, as a data memory such as a hard disk and/or a non-volatile memory and/or a memory card. The storage medium may, for example, be integrated in the computer.

Furthermore, the method according to the disclosure may also be executed as a computer-implemented method. Alternatively or additionally, at least one of the disclosed method steps may be computer-implemented and/or performed automatically.

### BRIEF DESCRIPTION OF THE DRAWINGS

Further advantages, features and details of the disclosure will be apparent from the following description, in which exemplary embodiments of the disclosure are described in detail with reference to the drawings. In this case, the features mentioned in the claims and in the description may in each case be essential to the disclosure individually or in any desired combination. They show:

FIG. 1 a schematic visualization of a method, a device, a storage medium, and a computer program according to exemplary embodiments of the disclosure,

FIG. 2 a schematic illustration of a simplified architecture according to exemplary embodiments of the disclosure.

### DETAILED DESCRIPTION

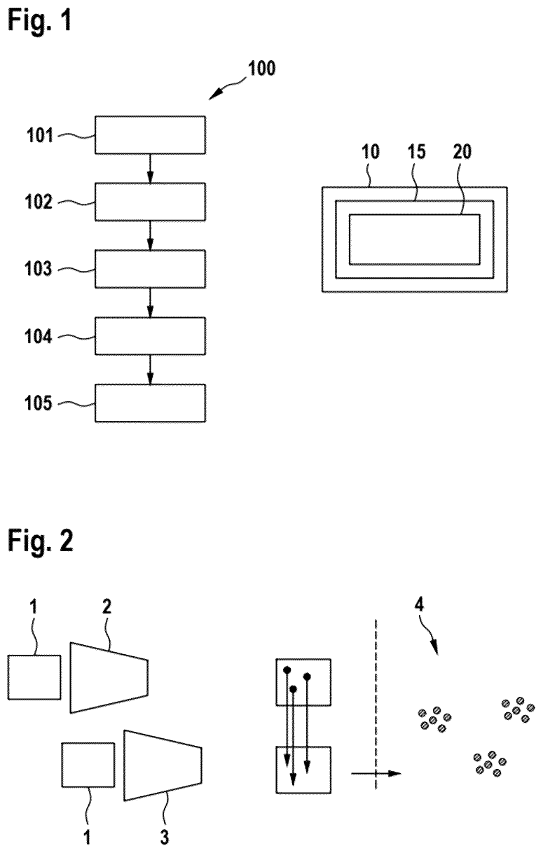

FIG. 1 schematically illustrates a method 100, a device 10, a storage medium 15, and a computer program 20 according to exemplary embodiments of the disclosure.

In particular, FIG. 1 shows an exemplary embodiment of a method 100 for determining at least one error type of a machine learning model 2, in particular a computer vision model. In a first step 101, an assessment criterion for an output of a prediction of the machine learning model 2 is defined. In a second step 102, the prediction is performed based on at least one image using the machine learning model 2, wherein the prediction is performed for individual areas of the at least one image. In a third step 103, the output of the prediction performed is analyzed to identify at least one area in the at least one image 1, for which the output of the prediction satisfies the defined assessment criterion. In a fourth step 104, local language embedding is generated for the at least one identified area. In a fifth step 105, the at least one error type is determined based on an analysis of the generated local language embedding.

According to exemplary embodiments of the disclosure, an automated approach is provided for detecting and understanding error types of a machine learning model 2, in particular a computer vision model. A vision language model 3, in particular a trained vision language model 3, can be used to generate local language embeddings for at least one image 1. Such local language embeddings are generated, for example, for areas in the at least one image 1, in which the precision of machine learning model 2 is below a defined threshold. As a result, a collection of local language embeddings can be provided for different error types. These local language embeddings can then be grouped into clusters 4 to derive a description of the underlying error type (e.g., “The model fails due to partially obscured cars in the presence of fog”).

Given the approaches in the prior art, for example, the question of how error types of a machine learning model 2 can be understood in detail by using information beyond global image information remains open. Global language embeddings include, in particular, only broad information such as, “Night Traffic Scene.”

Local language embedding, on the other hand, can include much more information, such as, “a back side of a truck on a night highway that is partially obscured by another truck.” More specific error types can thereby be determined, such as the fact that the machine learning model 2 will only fail in the case of partially obscured vehicles, or that the machine learning model 2 will only fail if a vehicle is visible from a particular perspective.

A simplified architecture according to the disclosure is shown in FIG. 2. Here, an input is, for example, an image 1 and p is, for example, a pixel position in the image 1. An output of a prediction of the machine learning model 2 at a particular pixel position may be referred to as f(p) and a confidence or precision of the prediction of the machine learning model 2 may be referred to as c(p). When predicted based on the at least one image 1, c(p) may be derived from a corresponding ground truth, in particular a ground truth label, which may also be referred to as precision in the context of the present disclosure. When the machine learning model 2 is applied without ground truth, c(p) may be obtained as a confidence value determined by the machine learning model 2 itself. In the following sections, in particular, the term precision is used for both of the aforementioned cases for simplification.

As part of the method according to the disclosure, a (local) vision language model 3 (VLM) may be used to calculate local language embeddings e(p) for the at least one image 1. For example, PixelLLM (Xu et al. 2023) may be used. However, the disclosure does not depend in particular on an exact choice of the vision language model 3. For the output of the prediction, an assessment criterion such as a threshold value cₜₕᵣₑₛₕ may be defined. For image positions with a precision {pᵢ} less than the defined threshold value cₜₕᵣₑₛₕ, associated local language embeddings {e(pᵢ)} may now be generated or retrieved.

After the local language embeddings of all areas having the precision less than the defined threshold value cₜₕᵣₑₛₕ have been collected from the at least one image 1, these local language embeddings may be grouped into clusters 4 in a further step. To this end, any suitable clustering algorithm may be used to generate n clusters 4 of local language embeddings associated with different error types. A focus of each cluster 4 may be considered a representative local language embedding for the associated error type.

As an optional step, the local language embeddings, in particular the representative local language embeddings, can be converted into natural language, e.g., directly using a generative model or indirectly based on similarity assessments for language embeddings of predefined text excerpts.

Either the local language embeddings or the resulting natural language of the local language embeddings may be used in an automated image retrieval pipeline that selects additional images or entire data sets for retraining or fine-tuning of the machine learning model 2 based on the local language embeddings or the resulting natural language.

Instead of using a clustering algorithm, the local language embeddings {e(pᵢ)} can be further processed by a deep learning machine learning model to extract relevant error types.

In addition to local language embeddings of low-precision areas, language embeddings of high-precision areas may also be extracted. These high-precision language embeddings may serve as a guide for post-processing (e.g., clustering according to the disclosure), as the error types should preferably be different from clusters 4 with high precision.

The foregoing explanation of the exemplary embodiments describes the present disclosure exclusively in the context of examples. Of course, individual features of the embodiments can be freely combined with one another, if technically feasible, without leaving the scope of the present disclosure.

What is claimed is:

1. A method for determining at least one error type of a machine learning model, comprising:
defining an assessment criterion for an output of a prediction of the machine learning model;
performing the prediction based on at least one image using the machine learning model, wherein the prediction is performed for individual areas of the at least one image;
analyzing the output of the performed prediction to identify at least one area in the at least one image for which the output of the prediction satisfies the defined assessment criterion;
generating local language embedding for the at least one identified area; and
determining the at least one error type based on an analysis of the generated local language embedding.

2. The method according to claim 1, wherein the assessment criterion is a threshold for a precision of the output of the prediction and the analysis is performed based on a comparison of the output of the prediction with a ground truth for the at least one image.

3. The method according to claim 1, wherein:
as part of performing the prediction, a respective confidence for predicting the individual areas of the image is further determined,
the assessment criterion is a threshold for the confidence, and
the analysis is performed based on a comparison of the respective determined confidences with the threshold for the confidence.

4. The method according to claim 1, wherein:
generating the local language embedding is performed using a vision language model, and
the local language embedding comprises a feature vector representing the at least one identified area.

5. The method according to claim 1, wherein (i) as part of the analysis, a plurality of areas in the at least one image are identified, for which the output of the prediction satisfies the defined assessment criterion are identified, and (ii) generating the local language embedding is performed for each of the identified areas, the method further comprising:
clustering the generated local language embeddings, wherein similar error types are grouped into a respective cluster,
wherein determining the at least one error type comprises analyzing the respective clusters to determine a specific error type for each cluster.

6. The method according to claim 1, wherein determining the at least one error type comprises:
converting the generated local language embedding into a natural language using a generative machine learning model.

7. The method according to claim 1, further comprising:
initiating an output in accordance with an analysis of the at least one determined error type, wherein the output comprises an indication of a functionality of the machine learning model, and/or
wherein the output comprises an indication of further required training data for retraining the machine learning model, wherein the further required training data is specific to the at least one determined error type.

8. The method according to claim 1, further comprising:
initiating a provision of further training data based on an analysis of the at least one determined error type, wherein the further training data is specific to the at least one determined error type; and
training the machine learning model using the retrieved further training data.

9. A computer program, comprising commands which, when the computer program is executed by at least one computer, cause the latter to execute the method according to claim 1.

10. A device for data processing configured so as to carry out the method according to claim 1.

11. A computer-readable storage medium, comprising instructions which, when executed by at least one computer, cause said computer to carry out the method according to claim 1.

12. The method according to claim 1, wherein the machine learning model is a computer vision model.
